(19) United States
(12) Patent Application Publication
(10) Pub. No.: US 2008/0115067 A1
(43) Pub. Date: May 15, 2008

(54) METHOD AND SYSTEM FOR CONTROLLING SECURITY OF A USER INTERFACE IN A COMPUTER SYSTEM

(76) Inventors: James G. McLean, Fuquay-Varina, NC (US); William G. Pagan, Durham, NC (US)

Correspondence Address: SAWYER LAW GROUP LLP, PO BOX 51418, PALO ALTO, CA, 94303, US

(21) Appl. No.: 11/560,224

(22) Filed: Nov. 15, 2006

(51) Int. Cl. G06F 17/00

(52) U.S. Cl. 715/751

(57) ABSTRACT

A method and system for controlling security on a user interface (UI) of a computer system are described. The method and system include allowing a user to mark a UI component as private. The UI component is separately renderable on the UI. The method and system also include displaying the UI component on the UI and rendering a shared workspace such that display of the UI component on the shared workspace is precluded.

### FIELD OF THE INVENTION

The method and system relate to computer systems and more particularly, to controlling security of user interface.

### BACKGROUND

Users of computer systems employ shared workspaces for multiple tasks. Shared workspaces allow multiple users, typically on multiple computer systems, to collaborate while viewing the same content. As used herein, a shared workspace includes situations in which multiple users on multiple computer systems share a single workspace and in which a single user displays a workspace on a single computer to multiple individuals, for example in the context of sharing a screen or desktop via a network or presentation. Use of a shared workspace may improve the ability of multiple users to collaborate.

Although the shared workspace is beneficial, it is associated with security risks. In particular, use of the shared workspace may result in disclosure of confidential information. For example, while maintaining the shared workspace, a user may also have documents on other items that are confidential or contain private information open on the user interface (UI) of the computer system. Unless something is done to protect the security of such items, they will be displayed to all users of the shared workspaces. Consequently, the security of these items, and thus the computer system, may be compromised.

Conventional methods of protecting the security of the computer system exist. For example, a user may be allowed to define public or private regions of the display. Any item in the private region will not be displayed on the shared workspace, while any item in the public region is displayed on the shared workspace. Alternatively, a user may mark a specific desktop or application for sharing. Consequently, only items corresponding to that application or desktop are displayed in the shared workspace.

Although such conventional methods for improving the security of the UI exist, there are significant drawbacks. Although a user is allowed to mark regions of the display as private, if an item that is confidential is inadvertently moved out of the private region, the item is displayed on the shared workspace. Consequently, security of that item is compromised. Conversely, if an item that is meant to be shared is inadvertently moved from the public region to the private region, the item is not displayed on the shared workspace. In order to maintain security while allowing collaboration, the private region of the workspace may need to be repeatedly updated. As a result, collaboration via the shared workspace is made more problematic. Although marking an application as public allows the application to be shared, portions of the application which are desired to be kept confidential may not remain private. For example, a user may mark a word processing application for sharing. Thus, any documents open in the word processing application are viewable through the shared workspace. A user then either closes documents desired to remain private or risks compromising the confidentiality of the documents. Consequently, conventional mechanisms for controlling the security of the UI in the context of a shared workspace have significant shortcomings.

Accordingly, what is needed is an improved method an system for controlling security of computer systems, particularly in the context of shared workspaces. The present invention addresses such a need.

### BRIEF SUMMARY

A method and system for controlling security on a user interface (UI) of a computer system are described. The method and system include allowing a user to mark a UI component as private. The UI component is separately renderable on the UI. The method and system also include displaying the UI component on the UI and rendering a shared workspace such that display of the UI component on the shared workspace is precluded.

According to the method and system disclosed herein, security for the computer system may be improved.

### BRIEF DESCRIPTION OF SEVERAL VIEWS OF THE DRAWINGS

FIG. 1 depicts an exemplary embodiment of a system in which security of the UI may be controlled.

FIG. 2 a flow chart depicting an exemplary embodiment of a method for controlling security of a UI in a computer system.

FIG. 3 a flow chart depicting another exemplary embodiment of a method for controlling security of a UI in a computer system.

### DETAILED DESCRIPTION

The method and system relate to UI security in computer systems. The following description is presented to enable one of ordinary skill in the art to make and use the method and system and is provided in the context of a patent application and its requirements. Various modifications to the embodiments and the generic principles and features described herein will be readily apparent to those skilled in the art. Thus, the method and system are not intended to be limited to the embodiments shown, but is to be accorded the widest scope consistent with the principles and features described herein.

A method and system for controlling security on a user interface (UI) of a computer system are described. The method and system include allowing a user to mark a UI component as private. The UI component is separately renderable on the UI. The method and system also include displaying the UI component on the UI and rendering a shared workspace such that display of the UI component on the shared workspace is precluded

The method and system will be described in terms of particular user interface components. However, one of ordinary skill in the art will recognize that other user interface components may be used. The method is also described in the context of particular computer systems. However, one of ordinary skill in the art will readily recognize that other computer systems having additional and/or different components may be used.

The invention can take the form of an entirely hardware embodiment, an entirely software embodiment or an embodiment containing both hardware and software elements. In a preferred embodiment, the invention is implemented in software, which includes but is not limited to firmware, resident software, microcode, etc.

Furthermore, the invention can take the form of a computer program produce accessible from a computer-usable or computer-readable medium providing program code for use by or in connection with a computer or any instruction execution system. For the purposes of this description, a computer-usable or computer readable medium can be any apparatus that can contain, store, communicate, propagate, or transport the program for use by or in connection with the instruction execution system, apparatus, or device.

The medium can be electronic, magnetic, optical, electromagnetic, infrared, or semiconductor system (or apparatus or device) or a propagation medium. Examples of a computer-readable medium include a semiconductor or solid state memory, magnetic tape, a removable computer diskette, a random access memory (RAM), a read-only memory (ROM), a rigid magnetic disk and an optical disk. Current examples of optical disks include compact disk—read only memory (CD-ROM), compact disk—read/write (CD-R/W) and DVD.

A data processing system suitable for storing and/or executing program code will include at least one processor coupled directly or indirectly to memory elements through a system bus. The memory elements can include local memory employed during actual execution of the program code, bulk storage, and cache memories which provide temporary storage of at least some program code in order to reduce the number of times code must be retrieved from bulk storage during execution.

Input/output or I/O devices (including but not limited to keyboards, displays, pointing devices, etc.) can be coupled to the system either directly or through intervening I/O controllers.

Network adapters may also be coupled to the system to enable the data processing system to become coupled to other data processing systems or remote printers or storage devices through intervening private or public networks. Modems, cable modem and Ethernet cards are just a few of the currently available types of network adapters.

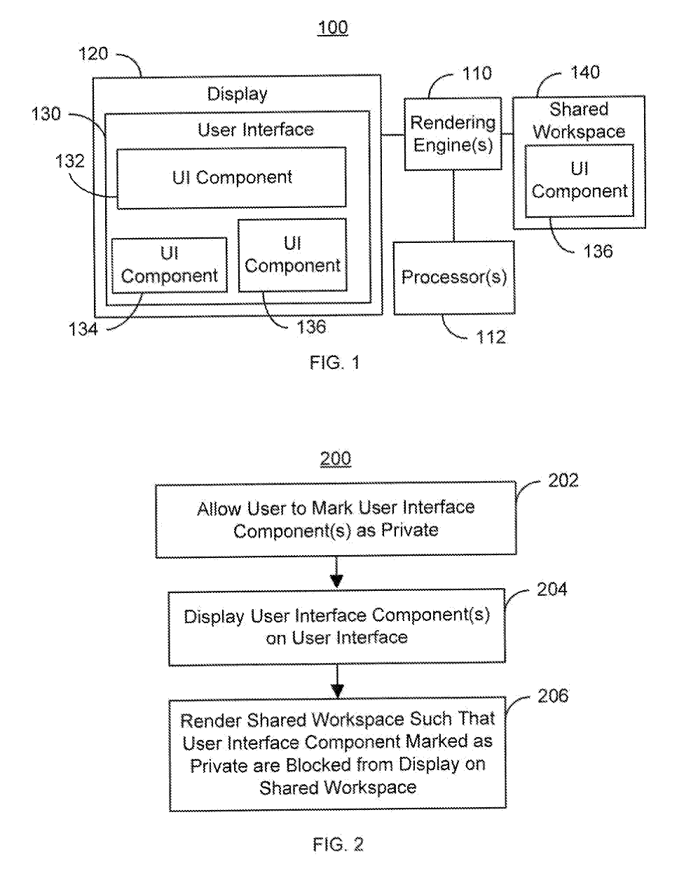

To more particularly describe the present invention, refer to FIG. 1 depicting a system 100 used in accordance with the present invention. The system 100 includes a rendering engine(s) 110, processor(s) 112, a display 120, and a shared workspace 140. The system 100 may include but is not limited to multiple computer systems (not separately shown) for collaborative work, for example via a network (not shown) and/or the Internet (not shown) or may include a single computer system in conjunction with an auxiliary device on which the shared workspace 140 is displayed. The display 120 has a corresponding UI 130. The UI 130 is rendered on the display 120 of the computer system 100. The shared workspace 140 is typically displayed on an auxiliary device, such as a projector or the display of another computer system. The UI 130 and shared workspace 140 may be rendered using the rendering engine(s) 140 or analogous component(s). Thus, rendering of the shared workspace 140 and the UI 130 may be considered to be controlled by a single rendering engine 110. In an alternate embodiment, the rendering engine(s) 110 may include multiple rendering engines 110 in multiple computer systems for the UI 130 and the shared workspace 140.

Some or all of the UI 130 may be rendered on the shared workspace 140, depending upon the selections made by the user. The UI 130 includes UI components 132, 134, and 136. A UI component 132, 134, or 136 is an item that is separately renderable by the rendering engine(s) 110. Examples of UI components 132, 134, and/or 136 include but are not limited to an application, a window of the application; a document of the application, parent and child documents of an application, a button, a field, a text area, a window frame, a dialog box, a menu, a menu item, a subframe, a desktop display, any desired item separately renderable on the UI 130. Thus, the UI component 132, 134, or 136 may have a fine granularity (e.g. a field, a menu item, a document, or a button) or a large granularity (e.g. an application or a desktop).

One or more of the UI components 132, 134 and 136 may be marked as private. In the embodiment shown, the UI components 134 and 136 have been marked as private. For each private UI components 132 and 134, the system 100 is configured such that the rendering engine(s) 110 render the UI component 132, 134 and/or 136 on the UI 130 of the display 120 for the system 100, but blocks the UI component 132 and 134 marked as private from being displayed on the shared workspace 140. As a result, a range of granularities of the items may be kept private. Thus, security of the UI 130 may be improved.

FIG. 2 a flow chart depicting an exemplary embodiment of a method 200 for controlling security of a UI in a computer system. For clarity the method 200 is described in the context of the computer system 100. However, the method 200 may be used in conjunction with another computer system (not shown) having different and/or additional components not inconsistent with the method 200. A user is allowed to mark one or more UI component(s) 132, 136, and/or 136 as private, via step 202. Step 202 preferably includes allowing a user to employ a menu item, a toolbar, a privacy button, or a task manager bar privacy selection to mark particular UI component(s) 132, 134, and/or 136 as private. In addition, the selection made in step 202 preferably allows a user to specify whether child UI component(s) of a particular UI component 132, 134, and/or 136 should automatically also be be marked private. For example, if a user is allowed to mark a document of application as private in step 202, step 204 may include allowing the user to specify whether new documents (e.g. child documents) generated from the marked document (e.g. parent document) should be treated in a like matter. Stated differently, the user is allowed to select whether the privacy selection made in step 202 is inheritable. In the particular embodiment shown in the system 100, the UI component 132 and 134 have been marked as private, either individually or because one UI component 132 or 134 inherited its privacy from the other parent UI component 134 or 132, respectively.

The UI component(s) 132, 134 and 136 are displayed on the UI 130 of the computer system, via step 204. In step 204 the rendering engine(s) 110 preferably render the UI components 132, 134, and 136 as well as any other portions of the UI 130 on the display 120. It is presumed that the UI 130 is private and/or secure. However, if only a portion of the UI 130 is private/secure, then step 204 may actually display the UI component(s) only on the secure portion of the UI 130. Consequently, UI component(s) 132, 134, and 136 are rendered in a secure manner for the user. The shared workspace 140 is rendered such that the UI component(s) 132 and 134 marked as private are blocked from display on the shared workspace 140, via step 206. Thus, in step 206, the UI component(s) 132 and 134 marked as private may not be displayed on an auxiliary device such as a projector or other work station. Step 206 is preferably performed using the rendering engine(s) 110.

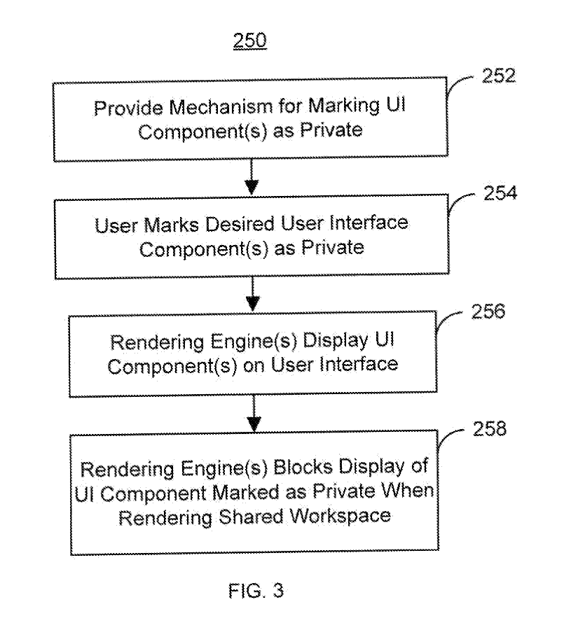

FIG. 3 a flow chart depicting another exemplary embodiment of a method 250 for controlling security of a UI in a computer system. For clarity the method 250 is described in the context of the computer system 100. However, the method 250 may be used in conjunction with another computer system (not shown) having different and/or additional components not inconsistent with the method 250.

A mechanism for allowing the user to mark the UI components 132, 134, and/or 136 as private is provided in the system 100, via step 252. For example, step 252 could include providing a feature such that a right-click on a UI component such as a field results in a context menu indicating that the user can make the field private, a window could include a button in addition buttons such as minimize, restore and close buttons which allows a user to toggle privacy, or a feature in the application bar or task manager could allow a user to select privacy. In addition, step 252 may include providing a mechanism for indicating whether privacy is inherited from parent to child UI components 132, 134, and 136. For example, as depicted in FIG. 1, the UI component 132 may be a parent component such as an application or document and the UI component 134 may be a child component such as a document of the application or field of the document, respectively. In addition to a mechanism for accepting user input regarding privacy of UI components 132, 134, and 136, step 252 includes providing an attribute, such as a privacy flag, for each desired UI component 132, 134, and/or 136. Depending on the status of the attribute, it can be determined whether the UI component 132, 134, and/or 136 is marked as private. For example, it may be determined whether the UI component 132, 134, and/or 136 is marked as private based on whether its privacy flag is set.

A user marks the UI component 132 and 134 as private using the feature previously provided, via step 254. Also in step 254, the user specifies whether child UI component(s) of a particular UI component 132 and 134 should also be marked private. In addition, in some embodiments, step 254 includes the user specifying how the UI component 132, 134, and/or 136 marked as private are to be precluded from display on the shared workspace 140. For example, in step 252, a user may select whether to have the UI component 132, 134 and/or 136 appear blacked out, invisible (e.g. by rendering the underlying a potions of the shared workspace 16, or replaced with given text, such as an error message. In step 254, therefore, the user employs the mechanism provided in step 252.

The rendering engine(s) 110 displays the UI components 132, 134, and 136 on a secure portion of the UI 130 of the computer system, regardless of their privacy, via step 256. Thus, the rendering engine(s) 110 preferably render the UI components 132, 134, and 136 as well as any other portions of the UI 130 on the display 120. The rendering engine(s) also block display of the UI component(s) 132 and 134 marked as private when rendering the shared workspace 140, via step 258. In a preferred embodiment, different rendering engines perform the steps 256 and 258—one for the UI 130 and one for the shared workspace 140. Thus, in step 258, the UI component(s) 132 and 134 marked as private may not be displayed on an auxiliary device such as a projector or other work station.

Thus, using the method 200 and/or 250 and for the system 100, security of the UI 130 may be more efficiently maintained. The privacy and attendant blocking of display on a shared workspace 140 follows individual UI components 132, 134, and/or 136 rather than a selected portion of the display 120. As a result, the user need not update privacy of regions of the display 120 in real time. Moreover, the granularity of the privacy can be controlled at a UI component 132, 134, and 136 level. Consequently, security of the UI 130 may be controlled at a wide range of granularities. As a result, the flexibility and efficiency of security of the UI 130 may be improved.

A method an system for controlling security of a UI in a computer system are described. The method and system have been described in accordance with the exemplary embodiments shown, and one of ordinary skill in the art will readily recognize that there could be variations to the embodiments, and any variations would be within the spirit and scope of the method and system. Accordingly, many modifications may be made by one or ordinary skill in the art without departing from the spirit and scope of the appended claims.

We claim:

1. A method for controlling security of a user interface (UI) in a computer system, the method comprising:
allowing a user to mark a UI component as private, the UI component being separately renderable on the UI;
displaying the UI component on the UI; and
rendering the UI component such that display of the UI component on a shared workspace is precluded.

2. The method of claim 1 wherein the UI component includes at least one of a window of an application; a document of the application, a button, a field, the application, a text area, a window frame, a document, a dialog box, a menu, a subframe, and a desktop display.

3. The method of claim 1 wherein the UI component is an application and wherein the rendering further includes:
precluding a UI sub-component of the application from being rendered on the shared workspace.

4. The method of claim 1 wherein the allowing the user to mark the UI component as private further includes:
providing at least one of a privacy button, a privacy menu item and a task manager bar privacy selection for the marking the UI component as private.

5. The method of claim 1 wherein the UI component is a parent UI component having at least one child UI component, and wherein the rendering further includes:
rendering the shared workspace such that display of the UI component and the at least one child component on the shared workspace are precluded.

6. The method of claim 1 wherein the rendering further includes:
at least one of rendering the UI component as black, replacing the UI component with predetermined data, not updating a portion of the shared workspace on which the UI component would otherwise be rendered, and rendering the portion of the shared workspace such that the UI component appears invisible.

7. A computer-program product including a program for controlling security of a user interface (UI) in a computer system, the program including instructions for:
allowing a user to mark a UI component as private, the UI component being separately renderable on the UI;
displaying the UI component on the UI; and
rendering the UI component such that display of the UI component on a shared workspace is precluded.

8. The computer-program of claim 7 wherein the UI component includes at least one of a window of an application; a document of the application, a button, a field, the application, a text area, a window frame, a document, a dialog box, a menu, a subframe, and a desktop display.

9. The computer-program of claim 7 wherein the UI component is an application and wherein the rendering instructions include instructions for:
precluding a UI sub-component of the application from being rendered on the shared workspace.

10. The computer-program of claim 7 wherein the allowing the user to mark the UI component as private further includes instructions for:
providing at least one of a privacy button, a privacy menu item and a task manager bar privacy selection for the marking the UI component as private.

11. The computer-program of claim 7 wherein the UI component is a parent UI component having at least one child UI component, and wherein the rendering instructions further include instructions for:
rendering the shared workspace such that display of the UI component and the at least one child component on the shared workspace are precluded.

12. The computer-program of claim 7 wherein the rendering further includes:
at least one of rendering the UI component as black, replacing the UI component with predetermined data, not updating a portion of the shared workspace on which the UI component would otherwise be rendered, and rendering the portion of the shared workspace such that the UI component appears invisible.

13. A computer system comprising:
a user interface (UI), the user interface capable of including a shared workspace;
a UI component marked as private, the UI component being separately renderable on the UI; and
a rendering engine that renders the UI such that the UI component is displayed on the UI and precludes display of the UI component on a shared workspace.

14. The computer system of claim 13 wherein the UI component includes at least one of a window of an application; a document of the application, a button, a field, the application, a text area, a window frame, a document, a dialog box, a menu, a subframe, and a desktop display.

15. The computer system of claim 13 wherein the UI component is an application and wherein the rendering engine further precludes a UI sub-component of the application from being rendered on the shared workspace.

16. The computer system of claim 13 further comprising:
a mechanism for allowing the user to mark the UI component as private.

17. The computer system of claim 13 wherein the mechanism further includes means for providing at least one of a privacy button, a privacy menu item and a task manager bar privacy selection for the marking the UI component as private.

18. The computer system of claim 13 wherein the UI component is a parent UI component having at least one child UI component, and wherein the rendering engine further renders the shared workspace such that display of the UI component and the at least one child component on the shared workspace are precluded.

19. The computer system of claim 13 wherein the rendering engine further renders the UI using at least one of rendering the UI component as black, replacing the UI component with predetermined data, not updating a portion of the shared workspace on which the UI component would otherwise be rendered, and rendering the portion of the shared workspace such that the UI component appears invisible.
